(19) United States
(12) Patent Application Publication
(10) Pub. No.: US 2011/0000744 A1
(43) Pub. Date: Jan. 6, 2011

(54) STAIRLIFTS

(76) Inventor: Leonard Smith, Hampshire (GB)

Correspondence Address: NIXON & VANDERHYE, PC, 901 NORTH GLEBE ROAD, 11TH FLOOR, ARLINGTON, VA, 22203, US

(21) Appl. No.: 12/599,587

(22) PCT Filed: May 14, 2008
(86) PCT No.: PCT/GB2008/001665

§ 371 Date: Aug. 26, 2010

(30) Foreign Application Priority Data
May 18, 2007 (GB) 0709551.6

(51) Int. Cl. B66B 9/08; G06F 19/00

(52) U.S. Cl. 187/202; 700/213; 33/1 PT

(57) ABSTRACT

The invention provides a enhancement to stairlift safety by separately monitoring the angular movement of a stairlift chair levelling motor, and the angular position of a chair leveled by that motor. By comparing the angular positions, any failure in the levelling system can be readily determined and, in response, a seat locking device can be deployed.

### FIELD OF THE INVENTION

This invention relates to stairlifts and, in particular, to the safety system of a stairlift.

### BACKGROUND TO THE INVENTION

In a curved stairlift installation the angle of the stairlift rail varies with respect to a horizontal plane. As the stairlift carriage moves over a transition bend (a bend in a vertical plane) the chair mounted on that carriage, must be kept level. In the embodiment of stairlift described in our European Patent No. 0 738 232 the chair is pivotally mounted on the carriage and a chair levelling motor operates to keep the chair level as the angle of the rail varies.

An arrangement of the type shown in EP 0 738 232 gives rise to a concern that, in the event of failure of the carriage levelling motor, or failure in the connection between the carriage levelling motor and the chair, the chair could rotate in an uncontrolled manner relative to the carriage. Obviously, in the event of a failure of one of these types, a person seated in the chair could be injured. Mindful of the possibility of such failures, EP 0 738 232 also describes the use of a safety arrangement in which a pair of mercury switches trigger the release of a locking pin when the chair angle reaches a predetermined off-level upper limit on either side of a central, level, position. The locking pin, in turn, extends into a locating aperture in the chair interface so as to lock the position of the chair relative to the carriage. The locking mechanism also triggers the main safety circuit which brings the carriage to a halt.

Since the filing of EP 0 738 278 it has become commonplace to substitute a single analogue tilt sensor for the mercury switches however, in common with the mercury switches, a tilt sensor only gives an output signal when the off-level limit is reached. This off-level limit is typically 5° and if failure occurs with the ±5° range, the chair may have built up considerable momentum before the failure is detected, the locking mechanism is triggered, and the locking mechanism engages. As a consequence, the chair will invariably exceed the intended 5° off-level limit and may do so to an uncomfortable and/or even dangerous extent.

It is an object of the invention to provide a safety method and apparatus for a stairlift which will go at least some way in addressing the aforementioned problems; or which will at least provide a novel and useful choice.

### SUMMARY OF THE INVENTION

Accordingly, in a first aspect the invention provides a method of providing a safety facility for a stairlift having a rail; a carriage moveable along said rail; a chair mounted on said carriage, the position of said chair being adjustable so that said chair may be maintained level as the angle of said rail, relative to a horizontal plane, varies; a levelling motor, the output of which is applied to adjust the position of said chair in response to a variation in the angle of said rail; and a locking arrangement to lock the position of said chair, said method including generating a first count from the rotation of said output, generating a second count from the position of said chair; comparing the first count and the second count and triggering said locking mechanism when said first and second counts differ by a predetermined amount.

Preferably said method comprises generating said counts using two rotary encoders.

Preferably said chair is pivotally mounted with respect to said carriage, said method further including damping the rotational movement of said chair relative to said carriage.

In a second aspect the invention provides a stairlift having a rail; a carriage moveable along said rail; a chair mounted on said carriage, the position of said chair being adjustable so that said chair may be maintained level as the angle of said rail, relative to a horizontal plane, varies; a levelling motor, the output of which is applied to adjust the position of said chair in response to a variation in the angle of said rail; and a locking arrangement to lock the position of said chair, said apparatus being characterized in that it includes a first count generator operable to generate a first count from the rotation of said output, a second count generator operable to generate a second count from the position of said chair; and a processor operable to compare the first count and the second count and to trigger said locking mechanism when said first and second counts differ by a predetermined amount.

Preferably said chair is pivotally mounted on said carriage.

Preferably said first count generator and said second count generator are configured to provide outputs in a form suitable for digital processing.

Preferably said first count generator and said second count generator comprise rotary encoders. Preferably said rotary encoders output a plurality of pulses for each degree of movement.

The stairlift may further include damping means to damp the movement of said chair. The damping means may comprise a telescopic damper, a rotational damper or a friction damper.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

One working embodiment of the invention will now be described with reference to the accompanying drawings in which:

FIG. 1: shows a schematic rear view of a stairlift according to the invention;

FIG. 2: shows an isometric view of parts of a stairlift carriage incorporating the invention; and

FIG. 3: shows a view similar to FIG. 2 but with an additional component fitted.

### DETAILED DESCRIPTION OF WORKING EMBODIMENT

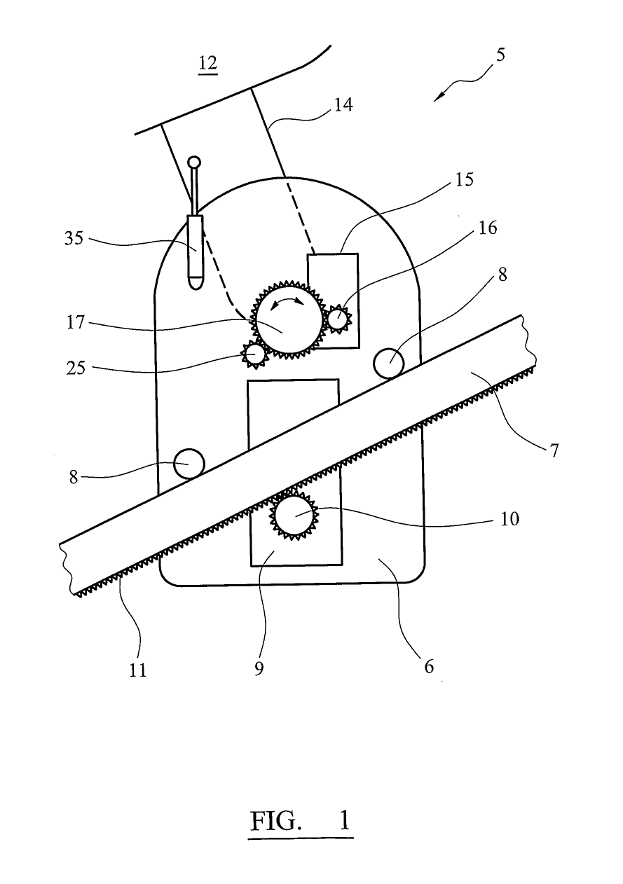

Referring to FIG. 1, the invention provides a stairlift 5 which includes a carriage 6 supported on a rail 7 by rollers 8. Mounted within the carriage 6 is a main drive motor 9 having a drive pinion 10 mounted on the output thereof. The drive pinion 10 engages a rack 11 so that as the drive motor rotates, the carriage 6 is driven along the rail 7.

A chair 12 is mounted on the carriage 6 in a manner such that that the same can be maintained level as the angle of the rail 7, relative to a horizontal plane, varies. In the particular embodiment shown in the drawings, the chair 12 is pivotally mounted on the carriage 6 and, when the carriage begins to traverse a section of rail at a different angle to a horizontal plane, the chair 12 is pivoted relative to the carriage 6. The chair is preferably mounted on a chair interface 14 and it is the interface which is directly and pivotally connected to the carriage.

A chair levelling motor 15 having a pinion 16 mounted on the output thereof, is also mounted in the carriage. Pinion 16 is in mesh with a further gear 17 fixed to the chair interface 14. Thus, as the pinion 16 rotates, the chair 12 is pivoted relative to the carriage. In our European Patent (EP) 0 738 232 we describe a method of controlling the operation of the motor 15 to ensure the chair is maintained level as the angle of the rail 7 varies relative to a horizontal is plane. Other forms of levelling are also possible and the present invention is not limited in application to the levelling arrangement described in EP 0 738 232.

The present invention has been developed to ensure safety is maintained in the event of failure within the chair levelling motor 15 or in the drive between the pinion 16 and the gear 17. In the absence of a suitable safety mechanism, failure of either type would result in uncontrolled rotation of the chair 12 and likely injury to a person seated in the chair.

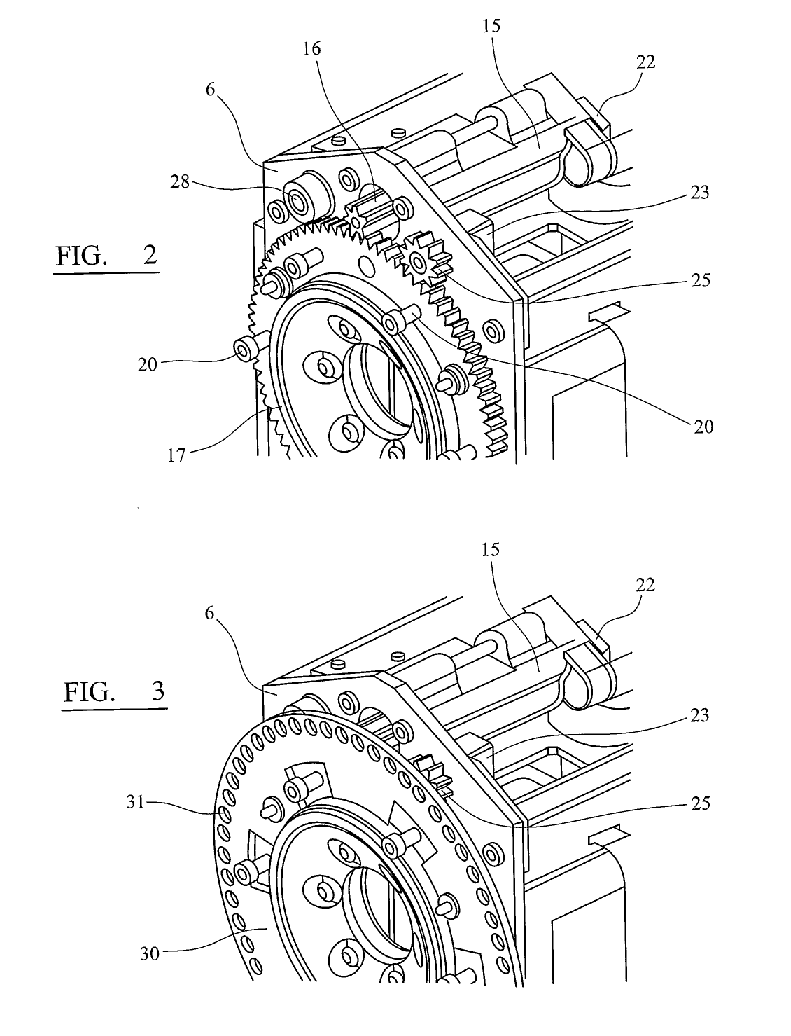

Referring now to FIGS. 2 & 3, chair levelling motor/gearbox unit 15 is shown mounted in the upper part of a stairlift carriage 6. As can be seen in FIG. 2, a pinion 16 is mounted on the output of the motor/gearbox unit 15, the pinion projecting through an aperture in the rear face of the carriage 6 to engage gear 17 which is rotatably mounted on the carriage 6. The chair interface (not shown) bolts to the gear 17 by means of screws 20.

According to the present invention the rotational output of the motor 15 is monitored and the rotational position of the chair is also monitored. The two are constantly compared and if they diverge in any unexpected way, a locking mechanism is triggered to lock the chair relative to the carriage.

It is convenient to undertake the monitoring and comparison using digital electronics and, to this end, a rotary encoder 22 is fixed to the output shaft of motor 15 while a second encoder 23 is connected to pinion 25, the pinion 25 also being in mesh with gear 17, but independently from drive pinion 16. The encoders 22 and 23 are preferably up-down counters, each giving an increasing count when the chair is pivoting in one direction and decreasing the count when the chair is pivoting in the opposite direction. The encoders are selected to provide a number of output pulses for each degree of rotational movement of the chair. By constantly comparing the pulse outputs of the is encoders 22 and 23, any unexpected variation, as would occur in the event of any type of failure in the levelling drive mechanism, is immediately detected. The outputs of the encoders are supplied to the electronic control unit (ecu) of the stairlift where the comparison is undertaken. In the event the ecu detects a variation in outputs outside an allowable range programmed into the ecu, the ecu triggers a locking mechanism to lock the chair relative to the carriage. In the form shown the locking mechanism comprises a solenoid operated plunger 28 which is held in the retracted position during normal operation. If and when the ecu detects a levelling drive failure, the solenoid releases the plunger which is then driven by spring bias into engagement with one of the holes 31 in index plate 30 (FIG. 3). As can be seen, index plate 30 is fixed to gear 17 and is configured so that holes 31 lie on the same pitch circle diameter as the plunger 28.

It will be appreciated that, given the accurate monitoring of both chair rotation and level motor rotation, and the rapid deployment of a locking mechanism, in the event of any failure within the level drive mechanism, the chair can be locked relative to the carriage, and the carriage halted, before the chair goes off-level to a dangerous extent.

To further enhance the safety system described above, the stairlift may be provided with a damper shown schematically at 35 in FIG. 1. The damper may be of any known form including telescopic, rotary or friction, and serves to damp any acceleration of the chair relative to the carriage in the event of failure of the types described above.

1. A method of providing a safety facility for a stairlift having a rail; a carriage moveable along a rail; a chair mounted on said carriage, the position of said chair being adjustable so that the chair may be maintained level as the angle of said rail, relative to a horizontal plane, varies; a levelling motor, the output of which is applied to adjust the position of said chair in response to a variation in the angle of said rail; and a locking arrangement to lock the position of said chair, said method including generating a first count from the rotation of said output, generating a second count from the position of said chair; comparing the first count and the second count and triggering said locking mechanism when said first and second counts differ by a predetermined amount.

2. A method as claimed in claim 1 comprising generating said counts using two rotary encoders.

3. A method as claimed in claim 1 wherein said chair is pivotally mounted with respect to said carriage, said method further including damping the rotational movement of said chair relative to said carriage.

4. A stairlift having a rail; a carriage moveable along a rail; a chair mounted on said carriage, the position of said chair being adjustable so that said chair may be maintained substantially as the angle of said rail, relative to a horizontal plane, varies; a levelling motor, the output of which is applied to adjust the position of said chair in response to a variation in the angle of said rail; and a locking arrangement to lock the position of said chair, said apparatus being characterized in that it includes a first count generator operable to generate a first count from the rotation of said output, a second count generator operable to generate a second count from the position of said chair; and a processor operable to compare the first count and the second count and to trigger said locking mechanism when said first and second counts differ by a predetermined amount.

5. A stairlift as claimed in claim 4 wherein said chair is pivotally mounted on said carriage.

6. A stairlift as claimed in claim 4 wherein said first count generator and said second count generator are configured to provide outputs in a form suitable for digital processing.

7. A stairlift as claimed in claim 4 wherein said first count generator and said second count generator comprise rotary encoders.

8. A stairlift as claimed in claim 7 wherein said rotary encoders output a plurality of pulses for each degree of movement.

9. A stairlift as claimed in claim 4 further including damping means to damp the movement of said chair.

10. A stairlift as claimed in claim 9 wherein the damping means comprise a telescopic damper, a rotational damper or a friction damper.
